(19) United States
(12) Patent Application Publication
(10) Pub. No.: US 2020/0210858 A1
(43) Pub. Date: Jul. 2, 2020

(54) NETWORK EMBEDDING METHOD

(71) Applicant: Universiteit Gent, Gent (BE)

(72) Inventors: Tijl DE BIE, Gent (BE); Bo KANG, Gent (BE); Jefrey LIJFFIJT, Gent (BE)

(21) Appl. No.: 16/235,467

(22) Filed: Dec. 28, 2018

(51) Int. Cl. G06N 5/02

(52) U.S. Cl. CPC G06N 5/022

(57) ABSTRACT

A computer-implemented conditional network embedding method to map nodes of a given network, comprises a set of links between the nodes, onto points in a d-dimensional Euclidean space wherein d is equal to 1 or larger. The method comprises identifying and modeling information about structural properties of the network related to the nodes and the set of links between them, and searching an embedding which maps information of the network which is not part of or implied by these structural properties onto points in the d-dimensional Euclidean space.

### FIELD OF THE INVENTION

The invention relates to the field of network embedding, also known as graph embedding. More specifically it relates to a method for mapping the nodes of a network onto points of a d-dimensional Euclidean space.

### BACKGROUND OF THE INVENTION

Given a network which comprises a set of nodes. In such a network each pair of nodes is connected or not. The nodes can for example represent people in a social network and the links (also known as edges) between the nodes may for example represent friendships. In another example the nodes can represent persons and products and the links represent which person is buying which product. Another example is a knowledge graph. In a knowledge graph triples are represented between two entities and a relation by which the entities are interconnected. In that case each node is an entity and a link between two nodes represents a certain relationship between the two entities these nodes represent. This can for example be the relationship between a person and a car if that person owns that car.

Finding missing links in such networks (throughout the description also referred to as graphs) is challenging. In a social network the missing links may for example be searched to propose new friendships. Recommender systems try to find missing links in networks that may for example comprise persons and products. A missing link in such a network is a missing link between a person and a product of which is assumed that the person would like to purchase the product. Another application may be to identify certain properties of the different nodes. These properties are also referred to as labels. Labels can for example represent the political orientation of a certain individual, or the age of an individual.

The most accurate prior art solutions to tackle these problems start from a network embedding (also known as graph embedding) of the network. Network embeddings map the nodes of a given network into d-dimensional Euclidean space [symbol] ^{d} (see for example FIG. 1) Hence, each node is represented by a list of d numbers. A point (also known as a vector) in the metric space is called an embedding of a node, and the set of points is called an embedding of the graph. The metric space may have an arbitrary number d of dimensions. A network embedding is more useful if it better represents information about the connectivity of the network. For example, ‘similar’ nodes may be mapped onto nearby points, such that the embedding can be used for purposes such as link prediction (if ‘similar’ means being ‘more likely to be connected’) or classification (if ‘similar’ means ‘being more likely to have the same label’).

In recent years various methods for network embedding have been introduced. These methods all follow a similar strategy, defining a notion of similarity between nodes on the network (typically deeming nodes more similar if they are nearby in the network in some metric), a distance metric or similarity measure in the embedding space, and minimizing a loss function that penalizes discrepancies between the similarity of pairs of nodes on the network versus similarities of (or conversely, distances between) their embeddings in the embedding space. A difficulty faced by existing methods is that certain networks are fundamentally hard to embed due to their structural properties, such as (approximate) multipartiteness, certain degree distributions, or certain kinds of assortativity.

The advantage of working with embeddings over working with graphs as combinatorial structures is that the embeddings are numeric vectors in a metric space and hence it is possible to do evaluations using numeric calculations. In the metric space it is for example possible to search for missing links based on the proximity of two node embeddings (points in the metric space). If the points are closer to each other the chances may be higher that the corresponding nodes in the graph are linked in the graph.

Another advantage of working with embeddings over working with graphs as combinatorial structures is that embeddings directly enable the use of a variety of machine learning methods (classification, clustering, etc.) on networks, explaining their exploding popularity. For example, some machine learning methods are designed to predict labels of for example objects. Most such machine learning methods have been designed for objects that can be represented as vectors. The position of the vectors in the metric space allows the machine learning method to classify them and predict the labels. After mapping the nodes of the network on the metric space it is possible to use the prior art machine learning methods to predict the labels.

Network embedding approaches typically have three components:

1. A measure of similarity between nodes. E.g. nodes can be deemed more similar if they are adjacent, or more generally within each other's neighborhood (link and path-based measures), or if they have similar functional properties (structural measures).
2. A distance metric or similarity measure in the embedding space.
3. A loss function that compares the distance or similarity between pairs of nodes in the embedding space with their similarity in the network.

Network embedding is then achieved by searching for an embedding of the nodes for which the average loss is minimized. A problem with all network embedding approaches is that networks are fundamentally more expressive than embeddings in Euclidean spaces. Consider for example a bipartite network G=(V, U, E) with V, U two disjoint sets of nodes and E⊆V×U the set of links. It is in general impossible to find an embedding in [symbol] ^{d} such that vϵV and uϵU are close for all (v, u)ϵE, while all pairs v,v′ϵV are far from each other, as well as all pairs u,u′ϵU. To a lesser extent, this problem will persist in approximately bipartite networks, or more generally (approximately) k-partite (wherein k is equal to 2 or larger) networks such as networks derived from stochastic block models.

Another more subtle example would be a network with a power law degree distribution. A general tendency in prior art network embedding methods will then be that high degree nodes are embedded towards the center of the embedding, while the low degree nodes will be on the periphery. Yet, this effect reduces the degrees of freedom to the embedding for representing similarity independent of node degree.

Typically, the expressive power of a graph is larger than the expressive power of the embedding. The reason is that if in a metric space a node A is similar (nearby) to a node B and a node B is similar to a node C, this implies that the node A cannot be too dissimilar from node C. In a graph that is not necessarily the case. A being linked to B and B being linked to C does not necessarily imply that A is linked to C. A network is thus more flexible in expressing similarities than a network embedding on its own.

There is therefore a need for methods that combine the advantages of embedding methods with the large expressive power of networks.

### SUMMARY OF THE INVENTION

It is an object of embodiments of the present invention to find a good mapping of the nodes of a given network onto points in a d-dimensional Euclidean space.

The above objective is accomplished by a method and device according to the present invention.

In a first aspect embodiments of the present invention relate to a computer-implemented conditional network embedding method to map nodes of a given network onto points in a d-dimensional Euclidean space wherein d is equal to 1 or larger. The network comprises a set of links between the nodes. The method comprises:

identifying and modeling information about structural properties of the network related to the nodes and the set of links between them,

searching an embedding of the network which represents information that is not part of or implied by these structural properties, by mapping each node in the network onto a point in a d-dimensional Euclidean space.

In embodiments of the present invention information of the network comprises information related to the nodes and the set of links between them. It is an advantage of embodiments of the present invention that the embedding is used to represent the detailed information (i.e. the more fine-grained information) which is not part of or implied by the structural properties.

In embodiments of the present invention modeling the information about the structural properties of the network comprises formalizing the information about the structural properties as a prior probability distribution P(G) over the set of links of the network.

In embodiments of the present invention the information about the structural properties is encoded in a probability distribution P(G) over a plurality of networks wherein the probability distribution indicates the probability that is attributed to the network G.

In embodiments of the present invention the plurality of networks has the same nodes as the network G but different links. The prior distribution of the links is encoded in the probability distribution.

In embodiments of the present invention the prior probability distribution over the set of links of the network is computed as a distribution of maximum entropy subject to the information about the structural properties of the network.

In embodiments of the present invention the probability distribution P(G) is factored as a product of independent Bernoulli distributions Pᵢⱼ(aᵢⱼ) over all unordered pairs of nodes i,jϵV, wherein V is a set of nodes in G, and wherein E is a set of pairs of nodes from V that are linked in G, and wherein aᵢⱼ=1 for linked node pairs {i, j}ϵE and aᵢⱼ=0 for unlinked node pairs {i, j}∉E, such that the probability distribution can be represented by means of a probability matrix P with element at row i and column j equal to Pᵢⱼ=Pᵢⱼ(1), the probability of a link between nodes i and j.

In embodiments of the present invention knowledge about the overall network density, and/or knowledge about the individual node degrees, and/or knowledge about the link density of particular subnetworks or more generally the number of ones in any specified subset of the entries of the adjacency matrix, leads to a probability distribution P(G) that can be represented using a probability matrix.

In embodiments of the present invention the network is a multi-partite network comprising a plurality of blocks and the information about the structural properties comprises which nodes are belonging to which block and the number of links between each pair of such blocks.

In embodiments of the present invention the information about the structural properties comprises a degree of connectivity of at least some of the nodes.

In embodiments of the present invention searching the embedding comprises searching an embedding X that maximizes a likelihood function P(G|X) which represents a posterior distribution over the set of links of the network given the embedding X when considered together with the probability distribution P(G).

It is an advantage of embodiments of the present invention that the most informative embedding can be found by maximizing the likelihood function P(G|X).

It is an advantage of embodiments of the present invention that Bayes' rule allows computing the posterior probability for the network conditioned on the embedding, such that the maximum likelihood embedding can be searched by maximizing this posterior probability.

In embodiments of the present invention the likelihood function P(G|X) is obtained by multiplying the probability distribution P(G) over the set of links of the network with a proper or improper conditional density function p(X|G) for the embedding X given the network and dividing it by a corresponding proper or improper marginal density function p(X) for the embedding X.

In embodiments of the present invention maximizing the likelihood function is based on a block stochastic gradient descent approach.

It is an advantage of embodiments of the present invention that efficient fitting can be achieved by a block stochastic gradient descent algorithm.

In embodiments of the present invention the proper or improper conditional density function p(X|G) for the embedding X given the network G is formulated as a product of density functions for pairs of the points in the embedding, wherein the mathematical form and wherein parameters of each of these density functions depend on the network G.

In embodiments of the present invention the mathematical form and the parameters of the density function for any pair of the points is independent of the network when conditioned on knowledge whether the nodes represented by these points are linked in the network.

In embodiments of the present invention the proper or improper conditional density function for any pair of points depends only on the pairwise distance between that pair of points in the embedding.

In embodiments of the present invention density functions for the distances between pairs of points are such that a standard deviation of the distances between pairs of points which represent linked nodes in the network is smaller than a standard deviation of the distances between pairs of points which represent unlinked nodes in the network.

It is an advantage of embodiments of the present invention that the difference in standard deviation ensures that the embedding reflects the neighborhood proximity of the network.

In a second aspect embodiments of the present invention relate to a link prediction method for predicting for any pair of nodes of a given network whether it is likely to be linked or unlinked in a more complete or more accurate version of the network than the given network, or whether it is likely to become linked or unlinked in the future as the network evolves. The method comprises applying a computer-implemented conditional network embedding method according to embodiments of the present invention on the given network and applying a link prediction algorithm on the obtained embedding in combination with the information about the structural properties of the network.

In embodiments of the present invention the link prediction method scores each pair of nodes using a posterior probability P(aᵢⱼ|X) for such pair of nodes to be linked or unlinked as computed from a likelihood function P(G|X) which represents a posterior distribution of the plurality of networks given the embedding X when considered together with the prior probability distribution P(G).

In a third aspect embodiments of the present invention relate to a label prediction method comprising a link prediction method according embodiments of the present invention, in a network augmented with a node for each possible label and a link between an original network node and an added label node whenever that label applies to that node, wherein a node is predicted to have a particular label if a link is predicted between that node and the corresponding label node by the link prediction method.

In a fourth aspect embodiments of the present invention relate to a recommender system comprising a link prediction method according embodiments of the present invention. The method comprises applying the link prediction method to a given network with consumers and consumables as nodes, wherein links in the given network indicate which consumables are relevant to which consumers (e.g. a consumable is linked to a consumer if that consumable was previously viewed, consumed, rated, or reviewed by the consumer), to obtain new predicted links between the consumers and consumables. A predicted link between a consumable and a consumer may then result in a recommendation of that consumable to that consumer.

In embodiments of the present invention the network may include other nodes representing attributes for the consumers and/or consumables that are linked to the nodes representing the consumers and/or consumables they apply to.

In a fifth aspect embodiments of the present invention relate to a network visualization method comprising applying a computer-implemented conditional network embedding in accordance with embodiments of the present invention, wherein identifying the information about the structural properties is selected such that certain information is filtered out, the method moreover comprises applying a link prediction algorithm on the obtained embedding.

In a further aspect embodiments of the present invention relate to an entity resolution method comprising a computer-implemented conditional network embedding method according to embodiments of the present invention. In such a method a distance between two node embeddings is used as a measure for the similarity between two nodes, and for the probability that they represent the same entity.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a prior art mapping of a given network onto points in a d-dimensional Euclidean space.

FIG. 2 shows an embedding obtained using a method with uniform prior, in accordance with embodiments of the present invention.

FIG. 3 shows an embedding obtained using a method wherein the individual degrees are encoded as prior, in accordance with embodiments of the present invention.

FIG. 4 and FIG. 5 shows the posterior distributions with different prior probabilities Pᵢⱼ and σ₂, in accordance with embodiments of the present invention.

FIG. 6 shows the entity relationship diagram of the studentdb dataset.

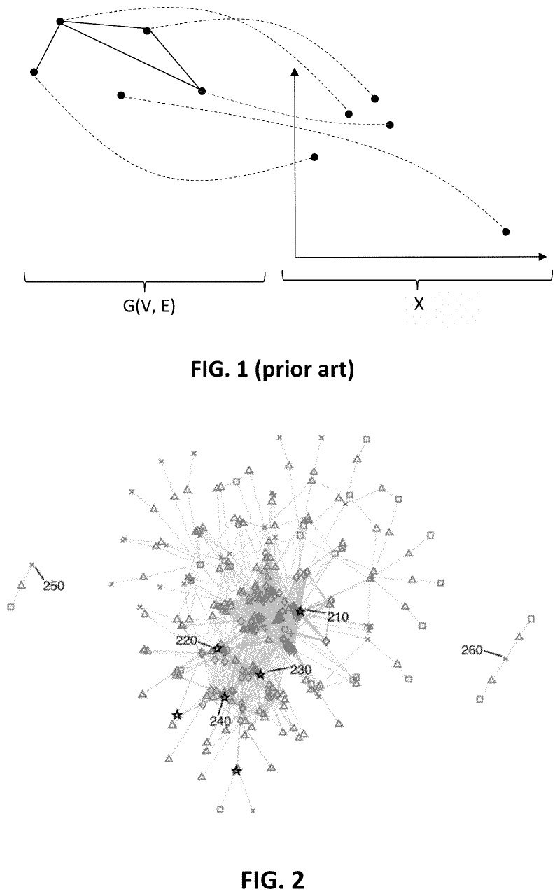

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect embodiments of the present invention relate to a computer-implemented conditional network embedding method to map the nodes of a given network, comprising a set of links, onto points in a d-dimensional Euclidean space.

The method comprises:

identifying and modelling information about structural properties of the network related to the nodes and the set of links between them,

searching an embedding which represents information about the network which is not necessarily part of or implied by these structural properties. Information of the nodes and the set of links between them which is not part of or implied by these structural properties is used to search the embedding onto points in the d-dimensional space.

In embodiments of the present invention embeddings are created that maximally add information with respect to structural properties of the network. In embodiments of the present invention the structural properties related to a node or set of nodes are stored separately and an embedding is searched which aims to optimally represent this information which is not part of or implied by the structural properties. The structural properties may for example include the block structure of a graph, the number of neighbors of nodes, the degree-assortativity or another type of assortativity.

In some prior art network embeddings, some of these types of structural properties are used, but only ever as an extra guidance to optimize the embedding so as to optimally represent information about the network, including and particularly these structural properties exhibited by the network. Prior art embeddings try to create the embedding such that the embedding represents as well as possible these structural properties.

In the present invention this is the opposite. The structural properties are represented differently than the embedding itself and the embedding is only used to represent the detailed information (i.e. the more fine-grained information) which is not part of or implied by the structural properties of the network.

Prior art network embedding methods are limited as they stand on themselves, without regard to any context or prior information about the local or global structure of the network. Some local or global structure may be hard to represent in a Euclidean space. It is advantageous that, in embodiments of the present invention, this information is represented or accounted for in another way. In embodiments of the present invention network embedding is proposed conditional on certain prior knowledge about the network, and more specifically about its structural properties.

Some networks may for example have a block structure. Examples of such networks are dating networks (here, blocks are determined by gender), knowledge graphs (because certain types of relationships are only possible between pairs of nodes of certain types), graphs that represent relational databases (in which entities and attribute values from the database are represented by nodes, and links represent relations between such entities and attribute values between which the relational schema allows relations to exist), with as a particular example databases of clients and products which store which client bought what, and which may also store properties of the clients (e.g. demographic properties, age) as well as properties of the products (e.g. price, product category). The structural properties of the networks representing such data are very difficult to represent when using prior art network embeddings.

It is an advantage of embodiments of the present invention that embeddings can be optimized with respect to, or conditional on, certain prior knowledge about the network's structural properties, formalized as a prior distribution over the links. This prior knowledge may itself be derived from the network itself such that no external information is required. It is the fact that embeddings in accordance with embodiments of the present invention are conditioned on such prior knowledge about certain structural properties of the network, that led to the name ‘conditional network embeddings’ to refer to such embeddings. The meaning of the concept ‘prior knowledge’ in this context must be interpreted as ‘knowledge available, acquired, or extracted prior to embedding the network’, and not necessarily as knowledge that is available already prior to having access to the network, or as prior knowledge that a human analyst is supposed to have about the domain of the network.

A combined representation of prior knowledge about the network's structural properties and a Euclidean embedding of the network makes it possible to overcome the problems highlighted in the examples above. For example, nodes in different blocks of an approximately k-partite network need not be particularly distant from each other if they are a priori known to belong to the same block (and hence are unlikely or impossible to be connected according to the prior knowledge). Similarly, high degree nodes need not to be embedded near the center of the embedding if they are known to be of high degree (i.e. if they are part of the prior knowledge about the network's structural properties), as it is then known that they are linked to many other nodes. The embedding can thus focus on encoding which nodes in particular any given node is connected to.

It is an advantage of embodiments of the present invention that the network embedding can be made more effective by requiring it to only reflect information of the network which is not part of or implied by the information about the structural properties of the network. It is, moreover, advantageous that this improved performance can be obtained with fewer dimensions (e.g. about 10 times fewer) than competing methods. Hence, significant computer storage and memory savings can be obtained.

Conditional network embedding in accordance with embodiments of the present invention may even result in faster embedding algorithms. It is moreover possible to do virtual experiments by varying the quantification of the structural properties (e.g. by varying the degrees of certain nodes, or the density of certain subnetworks, in the prior knowledge). Examples of such experiments would for example allow one to assess which unlinked pairs of nodes are likely to become linked if for example the block structure were to change, or if the degree of a node were to change.

In embodiments of the present invention the information about the structural properties is presented as prior knowledge over the graph (i.e. knowledge which is known or in principle accessible even if the embedding is not known). Prior knowledge may for example be how many neighbors a node has in the graph. In embodiments of the present invention the prior knowledge is encoded in a probability distribution. In embodiments of the present invention, this prior information is modelled as a prior probability model for the links in the network, i.e. for the connectivity of the network. The prior probability distribution over the different possible networks encodes the probability of one network with respect to another possible network with the same set of nodes, based solely on the structural properties considered. The prior distribution over all possible graphs G, P(G), represents the information about the structural properties considered. P(G) thereby is the chance that is attributed to a particular graph G. The more that the distribution attributes a higher probability to a limited number of graphs, the more informative the prior knowledge about the structural properties of the graph is. This prior knowledge thereby refers to knowledge prior to viewing the embedding. Combining the prior knowledge with a suitable embedding this results in a better knowledge of the graph than would be possible with the prior knowledge alone, or with an embedding alone.

Combined with a proper or improper conditional density function for the embedding X given the graph p(X|G), the prior probability distribution P(G) representing the prior knowledge about the structural properties allows one to derive the posterior probability distribution of the graphs G given an embedding X by applying Bayes' rule:

$$P ( G \vert X ) = \frac{p ( X \vert G ) \cdot P ( G )}{p ( X )}$$

wherein:
X: embedding
p(X|G): proper or improper conditional density function (conditional distribution) for the embedding X given the graph
p(X): proper or improper marginal density function (marginal distribution) for the embedding X
P(G): prior distribution representing the prior knowledge about the structural properties of the network
P(G|X): posterior probability distribution of the graphs G given an embedding X; also known as the likelihood of X given a graph G.

Where in embodiments of the present invention reference is made to a proper (conditional) density function, reference is made to a (conditional) density function that integrates to 1 over the domain of the random variable of which it is the (conditional) density function.

Where in embodiments of the present invention reference is made to an improper (conditional) density function, reference is made to a non-negative real-valued function that does not integrate to 1 over the domain of the random variable of which it represents the improper (conditional) density function.

An embedding X that maximizes the likelihood function P(G|X) best explains the graph G, when considered together with the information about the structural properties in P(G). In embodiments of the present invention the likelihood function P(G|X) depends on structural properties of G considered, as formalized in the prior P(G).

An example thereof is the following. In case it is known that two nodes are not connected. If it is certain that these nodes will not be connected, this can be represented as part of the prior knowledge of the structural properties of the graph and should not anymore be represented by the embedding. Thus by introducing this prior knowledge an increased number of degrees of freedom can be obtained for the embedding.

In the following paragraphs an exemplary conditional network embedding method in accordance with embodiments of the present invention is explained. In this exemplary method an undirected network is denoted G=(V, E) where V is a set of n=|V| nodes and

$$E ⊆ ( \begin{matrix}V \\ 2\end{matrix} )$$

is the link set (the set of all unordered pairs of nodes from V). A link is denoted by an unordered node pair {i, j}ϵE. Let Â be the adjacency matrix corresponding to network G, where its element âᵢⱼ=1 for {i, j}ϵE and aᵢⱼ=0 otherwise. The goal of network embedding is to find a mapping f:V→ [symbol] ^{d} from nodes to d-dimensional real vectors. The resulting embedding is denoted as Xϵ [symbol] ^{n×d}, X=(x₁, x₂, . . . , xₙ)′, where for each i, xᵢ is a d-dimensional real vector representing the embedding of node i.

In embodiments of the present invention network embedding is formalized as a Maximum Likelihood (ML) estimation problem. Namely, finding a maximally informative embedding X of a network G:

$${arg max}_{X} P ( G \vert X ) \qquad ( 1 )$$

The likelihood function P(G|X) is not postulated directly, as is common in ML estimation. Instead, a generic approach is used to derive prior distributions for the network P(G), and the density function is postulated for the data conditional on the network p(X|G). This strategy allows one to introduce the prior knowledge about the network structure into the formulation. Bayes' rule then allows one to derive the likelihood function as

$$P ( G \vert X ) = \frac{p ( X \vert G ) P ( G )}{p ( X )} .$$

Note that this approach is unusual: despite the usage of Bayes' rule, it is not Maximum A Posteriori (MAP) estimation as the chosen embedding X is the one maximizing the likelihood of the network.

In embodiments of the present invention a broad class of prior knowledge types (about different types of structural properties of the network) can be modelled in the form of a prior probability distribution for the network. This is achieved by assuming that the prior knowledge can be expressed as constraints on the expectations of the sum of various subsets of elements from the adjacency matrix. Prior knowledge about the overall density can trivially be expressed in this form, as well as prior knowledge about node degrees (where each subset of elements from the adjacency matrix consists of all elements in a particular row or column), and about the density of particular subnetworks (i.e. about a block structure of the network). This allows one to express, e.g., that certain subnetworks are dense, or two sets of nodes only have few connections in between, and thus also to express the exact or approximate k-partiteness of the network.

Generally speaking, with

$$S ⊆ ( \begin{matrix}V \\ 2\end{matrix} )$$

a subset of the elements of the adjacency matrix, the prior knowledge can thus be expressed in the form:

$$𝔼 \{ {\sum }_{\{ i , j \} ∈ S} {α}_{{i}_{j}} \} = {\sum }_{\{ i , j \} ∈ S} {\hat{a}}_{ij}$$

where the expectation [symbol] is taken with respect to the sought prior distribution for the network. Although such constraints impose constraints on the sought distribution P(G), they do not determine it fully.

Thus, the distribution of maximum entropy from all distributions satisfying all such prior knowledge constraints is chosen. It can be shown that the resulting maximum entropy distribution is a product of independent Bernoulli distributions, one for each element of the adjacency matrix:

P(G)=Π_{i,j}Pᵢⱼ^{â}^{ᵢⱼ}(1−Pᵢⱼ)^{1-â}^{ᵢⱼ} (2)

Where âᵢⱼ=1 if nodes i and j are linked in the network G, and âᵢⱼ=0 otherwise.

These Pᵢⱼ for P(G) the distribution of maximum entropy subject to such prior knowledge constraints can be expressed and efficiently computed in terms of a limited number of parameters—the Lagrange multipliers corresponding to the prior knowledge constraints. In embodiments of the present invention such prior network distributions may for example be used for the following kinds of prior knowledge: knowledge about the overall network density, knowledge about the individual node degrees, knowledge about the link density of particular node-induced subnetworks. In some cases, the number of parameters can be further reduced by exploiting symmetries between the prior knowledge constraints which will cause some of the Lagrange multipliers to be equal to each other at the optimum.

The likelihood function not only depends on the prior knowledge (i.e. the prior probability distribution P(G)), but also on the conditional density of the embedding given the network p(X|G). In embodiments of the present invention, this conditional density was proposed as follows. It assumes that any rotation or translation of an embedding is equally good, as it considers only the distances between pairs of nodes in the embedding as interesting. Thus, the sufficient statistics of this distribution are the pairwise distances between pairs of points, denoted as:

dᵢⱼ [symbol] ∥xᵢ−xⱼ∥₂

for points xᵢ, xⱼ ϵ [symbol] ^{d}. The conditional density for the distances dᵢⱼ given {i, j}ϵE can be modelled as a half-normal distribution with spread parameter σ₁>0:

p(dᵢⱼ|{i,j}ϵE)= [symbol] ₊(dᵢⱼ|σ₁²) (3)

and the distribution of distances dₖₗ with {k, l}ϵE as half-normal distribution with a larger variance σ₂>σ₁:

p(dₖₗ|{k,l}∉E)= [symbol] ₊(dₖₗ|σ₂²) (4)

The choice of 0<σ₁<σ₂ ensures the optimal embedding reflects the neighborhood proximity of the network. Indeed, the differences between the embedded nodes that are not connected in the network are expected to be larger than the differences between the embedding of connected nodes. Without losing generality (as it merely fixes the scale), σ₁ is set to 1 through this description.

It is clear that these distances are not independent of each other (e.g. the triangle inequality entails a restriction of the range of dᵢⱼ given the values of dᵢₖ and dⱼₖ for some k). This may make it difficult to derive a properly normalized density function p(X|G) from the conditional density functions for the pairwise distances in equations (3) and (4), which may be the case in embodiments of the present invention. Even though doing this may result in p(X|G) representing an improper distribution (i.e. not properly normalized), we still model the joint distribution of all distances (and thus of the embedding X up to a rotation/translation) as the product of the marginal densities for all pairwise distances:

p(X|G)=Π_{{i,j}ϵE} [symbol] ₊(dᵢⱼ|σ₁²)Π_{{k,l}ϵE} [symbol] ₊(dₖₗ|σ₂²) (5)

This allows one to compute the corresponding proper or improper marginal density p(X) as:

$$\begin{matrix}p ( X ) = {\sum }_{G} p ( X \vert G ) P ( G ) \\ = {\sum }_{G} {\prod }_{\{ i , j \} ∈ E} {𝒩}_{+} ( {d}_{ij} \vert {σ}_{1}^{2} ) {P}_{ij} \cdot {\prod }_{\{ k , l \} ∉ E} {𝒩}_{+} ( {d}_{kl} \vert {σ}_{2}^{2} ) ( 1 - {P}_{kl} ) \\ = {\prod }_{i , j} [ {𝒩}_{+} ( {d}_{ij} \vert {σ}_{1}^{2} ) {P}_{ij} + {𝒩}_{+} ( {d}_{ij} \vert {σ}_{2}^{2} ) ( 1 - {P}_{ij} ) ]\end{matrix} \qquad ( 6 )$$

In an exemplary method of the present invention the likelihood function (i.e. the posterior of the network conditioned on the embedding) may then be computed by a simple application of the Bayes' rule:

$$P ( G \vert X ) = \frac{p ( X \vert G ) P ( G )}{p ( X )} = {\prod }_{\{ i , j \} ∈ E} \frac{{𝒩}_{+} ( {d}_{i j} \vert {σ}_{1}^{2} ) {P}_{i j}}{{𝒩}_{+} ( {d}_{i j} \vert 0 , {σ}_{1}^{2} ) {P}_{i j} + {𝒩}_{+} ( {d}_{i j} \vert {σ}_{2}^{2} ) ( 1 - {P}_{i j} )} \cdot {\prod }_{\{ k , l \} ∉ E} \frac{{𝒩}_{+} ( {d}_{k l} \vert {σ}_{2}^{2} ) ( 1 - {P}_{k l} )}{{𝒩}_{+} ( {d}_{k l} \vert {σ}_{1}^{2} ) {P}_{k l} + {𝒩}_{+} ( {d}_{k l} \vert {σ}_{2}^{2} ) ( 1 - {P}_{k l} )} \qquad ( 7 )$$

This equation (7) is a proper posterior distribution for the network G given X even if p(X|G) is improper. It is, in this exemplary embodiment of the present invention, the likelihood function to be maximized in order to get the ML embedding. Note that the first set of factors for the linked pairs of nodes {i,j}ϵE are equal to the posterior probabilities of nodes i and j being linked under this model:

$$\frac{{𝒩}_{+} ( {d}_{i j} \vert {σ}_{1}^{2} ) {P}_{i j}}{{𝒩}_{+} ( {d}_{i j} \vert 0 , {σ}_{1}^{2} ) {P}_{i j} + {𝒩}_{+} ( {d}_{i j} \vert {σ}_{2}^{2} ) ( 1 - {P}_{i j} )} = P ( {a}_{i j} = 1 \vert X ) ,$$

while the second set of factors for the unlinked pairs of nodes {k, l}ϵE are equal to the posterior probabilities of nodes k and l not being linked:

$$\frac{{𝒩}_{+} ( {d}_{kl} \vert {σ}_{2}^{2} ) ( 1 - {P}_{kl} )}{{𝒩}_{+} ( {d}_{k l} \vert {σ}_{1}^{2} ) {P}_{kl} + {𝒩}_{+} ( {d}_{k l} \vert {σ}_{2}^{2} ) ( 1 - {P}_{kl} )} = P ( {a}_{kl} = 0 \vert X ) = 1 - P ( {a}_{kl} = 1 \vert X ) .$$

The most informative embedding can be found by maximizing the likelihood function P(G|X), or equivalently by maximizing the logarithm thereof. This is a non-convex optimization problem. It can for example be solved using a block stochastic gradient descent approach, explained below. The gradient of the logarithm of the likelihood function (Eq. (7)) with respect to the embedding of the embedding xᵢ of node i is (supplementary material for detailed derivations is present at the end of the detailed description):

$${∇}_{{x}_{i}} log ( P ( G \vert X ) ) = 2 {\sum }_{\{ i , j \} ∈ E} ( {x}_{i} - {x}_{j} ) P ( {a}_{i j} = 0 \vert X ) ( \frac{1}{{σ}_{2}^{2}} - \frac{1}{{σ}_{1}^{2}} ) + 2 {\sum }_{\{ i , j \} ∉ E} ( {x}_{i} - {x}_{j} ) P ( {a}_{i j} = 1 \vert X ) ( \frac{1}{{σ}_{1}^{2}} - \frac{1}{{σ}_{2}^{2}} )$$

This is equation (8).

As

$$( \frac{1}{{σ}_{2}^{2}} - \frac{1}{{σ}_{1}^{2}} ) < 0 ,$$

the first summation pulls the embedding of node i towards embeddings of the nodes it is connected to in G. Moreover, if the current posterior probability P(aᵢⱼ=1|X) of the link {i, j} is small (i.e., if P(aᵢⱼ=0|X)=1−P(aᵢⱼ=1|X) is large), the pulling effect will be larger. Similarly, the second summation pushes xᵢ away from the embeddings of unconnected nodes, and more strongly so if the posterior probability P(aᵢⱼ=1|X) of a link between these two unconnected nodes is larger. The magnitudes of the gradient terms are also affected by parameter σ₂ and prior P(G): a large σ₂ gives stronger push and pull effects. In the quantitative experiments described below σ₂ is set to 2.

Computing this gradient with respect to a particular node's embedding requires computing the pairwise differences between n proposed d-dimensional embedding vectors, with time complexity O(n² d) and space complexity O(nd). This is computationally demanding for mainstream hardware even for networks of sizes of the order n=1000 or more and dimensionalities of the order d=10 or more, quickly becoming prohibitive beyond that. To address this issue, in embodiments of the present invention both summations may be approximated in the objective by sampling k<n/2 terms from each. This amounts to uniformly sampling k nodes from the set of connected nodes (where aᵢⱼ=1), and k from the set of unconnected nodes (where aᵢⱼ=0). This reduces the time complexity to O(ndk). If a node i has a degree smaller than k, then more non-connected neighbors may be sampled to make sure that 2k points are used for the approximation of the gradient, and conversely if a node has a degree larger than n−k.

Given the embedding, the posterior probability of any given pair of nodes {i, j} being connected can then be computed as

$$P ( {a}_{i j} = 1 \vert X ) = \frac{{𝒩}_{+} ( {d}_{i j} \vert {σ}_{1}^{2} ) {P}_{i j}}{{𝒩}_{+} ( {d}_{i j} \vert 0 , {σ}_{1}^{2} ) {P}_{i j} + {𝒩}_{+} ( {d}_{i j} \vert {σ}_{2}^{2} ) ( 1 - {P}_{i j} )} .$$

These probabilities can be used directly for link prediction. For example, one may predict a link to exist between pairs of nodes for which P(aᵢⱼ=1|X) exceeds a specified value. Or, for a given node i one may predict a link to exist between {i, j} if P(aᵢⱼ=1|X) is amongst the top-K posterior probabilities amongst all P(aᵢₖ=1|X) for i≠kϵV, for some chosen K. Conversely, one may predict a link not to exist for pairs of nodes for which P(aᵢⱼ=0|X) 1−P(aᵢⱼ=1|X) exceeds a specified value. Or, for a given node i one may predict a link not to exist between {i, j} if P(aᵢⱼ=0|X) is amongst the top-K posterior probabilities amongst all P(aᵢₖ=0|X) for i≠kϵV, for some chosen K. Since these posterior probabilities depend on both the embedding (through their dependence on the dᵢⱼ) and on the prior knowledge constraints (through their dependence on the Pᵢⱼ), these link predictions rely on both the knowledge of the structural properties and the fine-grained information captured by the embedding.

In a second aspect embodiments of the present invention relate to a link prediction method for predicting any pair of nodes of a given network whether it is likely to be linked or unlinked in a more complete or more accurate version of the network than the given network, or whether it is likely to become linked or unlinked in the future as the network evolves. It comprises applying a computer-implemented conditional network embedding method according to embodiments of the present invention on the given network. The method moreover comprises applying a link prediction algorithm using the obtained embedding in combination with the information about the structural properties of the network.

In a third aspect embodiments of the present invention relate to label prediction for the nodes in a network, also known as classification, or more specifically multi-label classification when more than one label may apply to each node. A label prediction method comprises a link prediction method, according to embodiments of the present invention, which is applied to a network augmented with a node for each possible label and a link between an original network node and an added label node whenever that label applies to that node. A node is predicted to have a particular label if a link is predicted between that node and the corresponding label node by the link prediction method.

For example, in a social network, the nodes could represent individuals, while the labels could represent demographic information (gender, age, birth place, country of residence, etc). One approach to do this is by expanding the graph to include also nodes for the different labels. Then, a link is added between such a label node (e.g. a node representing a country in the social network example) and a normal network node (e.g. a node representing an individual) if that label applies to that node (e.g. if the country is the country of residence of that individual). Predicting links between normal network nodes and label nodes thus amounts to label prediction. The information on structural properties can then be related to the entire network, including the normal nodes and the label nodes.

A conditional network embedding method in accordance with embodiments of the present invention can not only be used for link and label prediction. It can also be used for entity disambiguation, also known as entity resolution, according to yet another aspect of the present invention. In such tasks, it is assumed that some nodes in the graph may in fact represent the same real-life entity, and one wishes to identify those sets of nodes that do represent the same real-life entity. A distance between two node embeddings can be used as a measure for the similarity between two nodes. A small distance between two nodes' embeddings is an indication for them representing the same real-life entity. The threshold for determining whether a distance is small can for example be pre-defined or can be obtained by calibration. Thus, the graph embedding can be used for entity disambiguation by applying a fine-grained distance-based clustering method to the set of node embeddings in the Euclidean space. Conditional network embedding methods in accordance with embodiments of the present invention are particularly advantageous for entity disambiguation if the structural information that is conditioned on is information about properties of nodes that may differ between different nodes that represent the same entity. An example of such structural information could be the degree of the nodes.

A conditional network embedding method in accordance with embodiments of the present invention can also be used for implementing a recommender system.

In a fourth aspect embodiments of the present invention relate to recommender systems. Such recommender systems comprise a link prediction system in accordance with embodiments of the present invention. The link prediction method is applied to a given network involving consumers (e.g. customers or similar) and consumables (e.g. products or similar) to be recommended to the consumers. A link between a consumer and a consumable in the given network indicates that the consumable is relevant to the consumer (e.g. previously viewed, consumed, rated, or reviewed by the consumer). The link prediction method is applied to the given network to obtain new links between consumers and consumables. The given network may for example comprise links which indicate that a customer has previously bought or otherwise expressed an appreciation for a consumable. The recommender system predicts new links where a predicted link between a customer and a consumable may result in a recommendation of that consumable to that customer.

Where the network is a network between nodes representing individuals and nodes representing products, with a node representing an individual linked to a node representing a product if that individual has purchased or liked that product. A recommender system built in this way is a variant of a collaborative filtering type of recommender system, as it uses known preferences of all individuals about all products (the existing links in the individual-product network) to understand better the preference of any particular individual for any particular product (a possible predicted link between the individual and the product). In addition, products and individuals can have particular attributes (properties), which can also be represented by nodes in the network linked to the individual or product nodes with those attributes. If such information is used as well, the resulting recommender system is also content-based, as it also uses information about the individuals and the products. Embodiments of the present invention can thus be used to build recommender systems that combine the benefits of collaborative filtering (namely the typically high accuracy when sufficiently many known preferences are available) with the benefits of content-based recommendations (namely the fact that there is no cold start problem, where no informed recommendations can be made of a new product or for a new individual).

In a fifth aspect embodiments of the present invention relate to a network visualization method. Such a method comprises applying a computer-implemented conditional network embedding method according to embodiments of the present invention, wherein the identified information about the structural properties is chosen so as to ensure that certain information is filtered out and not represented by the embedding. The method moreover comprises applying a link prediction algorithm on the obtained embedding.

A conditional network embedding method in accordance with embodiments of the present invention may also be used for network visualization, with the ability to filter out certain information by using it as a prior. For example, suppose the nodes in a network represent people working in a company with a matrix-structure (vertical being units or departments, horizontal contents such as projects) and links represent whether they interact a lot. If the vertical structure is known, the embedding can be constructed where the prior is the vertical structure. The information that the embedding will try to capture corresponds to the horizontal structure.

If the dimensionality d of the embedding space is small, then the embedding can be visually displayed in the form of a scatter plot (if the dimensionality is 2 or 3) or a number of scatter plots plotting one of the dimensions against another one (if the dimensionality is larger than 2). The embedding can then be used in downstream visual or automated analysis, e.g., to discover clusters that correspond to teams in the horizontal structure.

So far, the detailed description focused on one particular conditional probability density function p(X|G) (see Equation 5). In other embodiments of the present invention, the conditional probability density function p(X|G) may be another proper or improper conditional probability density function. For example, instead of the distances between all pairs of the node embeddings xᵢ as its sufficient statistics, its sufficient statistics may comprise the inner products of all pairs of node embeddings xᵢ, or the outputs of a deep or shallow artificial neural network with the node embedding pairs as its input. Moreover, in other embodiments of the present invention, the conditional density function p(X|G) may not be factorizable over the pairs of node embeddings, and even when it can, the density in one such factor may not be independent of the rest of the network when conditioned on the connectivity of the pair of nodes this factor applies to—it may for example also depend on the wider neighborhood of this pair of nodes, or on certain attributes or other information that may be known about them.

In the following paragraphs the network embedding obtained by a conditional network embedding (CNE) method, in accordance with embodiments of the present invention, on downstream tasks is evaluated. The downstream tasks are: link prediction, multi-label classification for nodes, and building a recommender system. Next is illustrated how to use a CNE method, in accordance with embodiments of the present invention, to visually explore multi-relational data.

For link prediction and multi-label classification, a CNE method according to embodiments of the present invention is evaluated against four state-of-the-art baselines for network embedding:

Deepwalk: This embedding algorithm learns an embedding based on the similarities between nodes. The proximities are measured by random walks. The transition probability of walking from one node to all its neighbors are the same and are based on one-hop connectivity.

LINE: Instead of random walks, this algorithm defines similarity between nodes based on first and second order adjacencies of the given network.

node2vec: This is again based on random walks. In addition to its predecessors, it offers two parameters p, q that interpolates the importance of BFS (breadth-first sampling) and DFS (depth-first sampling) like random walk in the learning.

metapath2vec++: This approach is developed for heterogeneous network embedding, namely, the nodes belong to different node types. methapath2vec++ performs random walks by hopping from a node form one type to a node from another type. It also utilizes the node type information in the softmax based objective function.

For all methods the default parameter settings reported in the original papers are used and d is set to 128. For node2vec, the hyperparameters p and q are optimized over a grid p, q E {0.25, 0.5, 1, 2, 4} using 10-fold cross validation. The experiments are repeated 10 times with different random seeds. The final scores are averaged over these 10 repetitions.

These methods are evaluated on the following datasets:

Facebook: In this network, nodes are the users and links represent the friendships between the users. The network has 4,039 nodes and 88,234 links.

arXiv ASTRO-PH: In this network nodes represent authors of papers submitted to arXiv. The links represent the collaborations: two authors are connected if they co-authored at least one paper. The network has 18,722 nodes and 198,110 links.

studentdb: This is a snapshot of the student database from the University of Antwerp's Computer Science department. There are 403 nodes that belong to one of the following node types including: course, student, professor, program, track, contract, and room. There are 3429 links that are the binary relationships between the nodes: student-in-track, student-in-program, student-in-contract, student-take-course, professor-teach-course, course-in-room. The entity relationship diagram of the studentdb dataset is illustrated in FIG. 6.

BlogCatalog: This social network contains nodes representing bloggers and links representing their relations with other bloggers. The labels are the bloggers' interests inferred from the meta data. The network has 10,312 nodes, 333,983 links, and 39 labels (used for multi-label classifications).

Protein-Protein Interactions (PPI): A subnetwork of the PPI network for Homo Sapiens. The subnetwork has 3,890 nodes, 76,584 links, and 50 labels.

Wikipedia: This network contains nodes representing words and links representing the co-occurrence of words in Wikipedia pages. The labels represent the inferred Part-of-Speech tags. The network has 4,777 nodes, 184,812 links, and 40 different labels.

In link prediction, randomly 50% of the links of a given network are removed while keeping the network connected. The remaining network is thus used for training the embedding, while the removed links (positive links, labeled 1) are used as a part of the test set. Then, the test set is topped up by an equal number of negative links (labeled 0) randomly drawn from the original network. In each repetition of the experiment, the node indices are shuffled with different random seeds in order to obtain a different split of train-test set.

A CNE method in accordance with embodiments of the present invention, further on in this evaluation referred to as CNE for short, is compared with other methods based on the area under a Receiver Operator Characteristic (ROC) curve, also known as the Area Under the Curve (AUC). The methods are evaluated against all datasets mentioned in the previous section. For CNE, it typically already works well with small dimensionality d and sample size k. In this experiment d is set to 8 and k is set to 50. Only for the arXiv network (which has large number of nodes/links), the dimensionality is increased to d=16 to reduce underfitting. To calculate AUC, first the posterior P(aᵢⱼ=1|Xₜᵣₐᵢₙ) of the test set of node pairs based on the embedding Xₜᵣₐᵢₙ learned on the training network is computed. Then the AUC score is computed by comparing the posterior probability of the test node pairs being linked with their true labels.

For reference, first CNE is compared against four simple baselines: Common Neighbors (|N(i)∩N(j)|), Jaccard Similarity

$$( \frac{\vert N ( i ) ⋂ N ( j ) \vert}{\vert N ( i ) ⋃ N ( j ) \vert} ) ,$$

### Adamic-Adar Score

$$( {Σ}_{t ∈ N ( i ) ⋂ N ( j )} \frac{1}{log \vert N ( t ) \vert} ) ,$$

and Preferential Attachment (|N(i)|·|N(j)|). These baselines are neighborhood-based node similarity measures. To compute the AUC score, for each test node pair these scores are computed on the training set. Those scores are then used to compute the AUC against the true labels of these node pairs.

For the network embedding baselines, link prediction using logistic regression based on the link representation derived from the node embedding Xₜᵣₐᵢₙ is performed. The link representation is computed by applying the Hadamard operator (element wise multiplication) on the node representations xᵢ and xⱼ. Then the AUC score is computed by comparing the link probability (as estimated by logistic regression) of the test links and their true labels.

The results for link prediction are summarized in table 1. In this table a conditional network embedding method in accordance with embodiments of the present invention is empirically compared with prior art methods by comparing the AUC scores for link prediction. Not all of these prior art methods are embedding methods. The first four methods are not embedding methods. Deepwalk, Line, node2vec and metapath2vec++ are network embedding methods that lead to state-of-the-art performances for link prediction. A general observation is that CNE outperforms all other methods. The scores for CNE with different priors are also compared. With uniform prior (when essentially no prior information on structural properties is provided other than the overall link density of the network—i.e. the total number of links—in which case Pᵢⱼ is constant w.r.t. the nodes i and j and equal to the fraction of node pairs that are linked in the network), CNE already outperforms most baselines. Using the degree prior, wherein the structural properties considered comprise the degree of connectivity of each of the nodes (where the degree of a node is the number of links incident to the node), further improves CNE's AUC scores. This is because the degree prior encodes more information about the network than the uniform prior. Note that for the multi-relational dataset studentdb, the metapath2vec++ baseline, as it was designed for heterogeneous data, outperforms other baselines, but it performs not as well as CNE. Furthermore, in the studentdb data there are different types of nodes, and the connectivity between sets of nodes of particular types varies considerably depending on those types. For example, certain node types cannot be connected to each other at all (i.e. link density zero), owing to the relation schema of the database this network was derived from. The number of links between nodes of two specified types can be incorporated as a block density prior on the adjacency matrix of the network. When doing this, the AUC score improves by almost 4% from the result obtained by CNE with degree prior.

TABLE 1

| | | | | Blog- | | |
|---|---|---|---|---|---|---|
| Algorithm | Facebook | PPI | arXiv | Catalog | Wikipedia | Studentdb |
| Common Neighbor | 0.9735 | 0.7693 | 0.9422 | 0.9215 | 0.8392 | 0.4160 |
| Jarcard Sim. | 0.9705 | 0.7580 | 0.9422 | 0.7844 | 0.5048 | 0.4160 |
| Adamic Adar | 0.9751 | 0.7719 | 0.9427 | 0.9268 | 0.8634 | 0.4160 |
| Prefere. Attach. | 0.8295 | 0.8892 | 0.8640 | 0.9519 | 0.9130 | 0.9106 |
| Deepwalk | 0.9798 | 0.6365 | 0.9207 | 0.6077 | 0.5563 | 0.7644 |
| LINE | 0.9525 | 0.7462 | 0.9771 | 0.7563 | 0.7077 | 0.8562 |
| node2vec | 0.9881 | 0.6802 | 0.9721 | 0.7332 | 0.6720 | 0.8261 |
| metapath2vec++ | 0.7408 | 0.8516 | 0.8258 | 0.9125 | 0.8334 | 0.9244 |
| CNE (uniform) | 0.9905 | 0.8908 | 0.9865 | 0.9190 | 0.8417 | 0.9300 |
| CNE (degree) | 0.9909 | 0.9115 | 0.9882 | 0.9636 | 0.9158 | 0.9439 |
| CNE (block) | NA | NA | NA | NA | NA | 0.9830 |

We next focus on label prediction, and more specifically on multi-label classification, which is the most general type of label prediction problem. In a multi-label classification setting, each node is assigned a subset of a given set of possible labels. Network embedding problems have been used for multi-label classification of the network's nodes, by using the embedding of the nodes as their feature vector, for use by a standard machine learning classifiers such as Logistic Regression (LR). When comparing CNE with multi-label classification it should be noted, however, that the embedding found by CNE should not be expected to perform well when used in this way, as a node's embedding will expressly not reflect information about the structural properties of the network, which is nonetheless likely to be relevant to the multi-label classification problem. Yet, the results are included here, so they can be contrasted with a more intelligent approach to using CNE for multi-label classification based on casting it as a link prediction problem. This standard approach of using CNE we will refer to as CNE-LR (with LR standing for Logistic Regression), where we use prior information on the nodes' degrees.

Multi-label classification can however also be cast as a link prediction problem—a task CNE is designed to perform well at. This is done by inserting a node into the network corresponding to each of labels, and linking the original nodes to the label nodes if they have that label. Then doing link prediction between the original nodes and the label nodes is equivalent to multi-label classification. We evaluated all link prediction methods discussed above also in this setting, and will refer to this approach when used in combination with CNE as CNE-LP (with LP standing for Link Prediction).

The multi-label classification evaluation is performed on the following datasets: BlogCatalog, PPI, and Wikipedia. For CNE, the embeddings are obtained with d=32 and k=150 (without optimizing these hyperparameters).

To evaluate these methods for multi-label classification, we use the labels of a random selection of 50% of the nodes for training (the training set), and the labels of the remaining 50% of the nodes for evaluation (the test set). When using the embeddings as feature vectors to feed into a logistic regression classifier (the standard approach in prior art), the node embeddings are first trained on the full network. Then an L2-regularized logistic regression classifier is trained, with the embeddings as feature vectors for the nodes, on the nodes in the training set—and this for each of the labels. The regularization strength parameter of each of the classifiers is trained with 10-fold cross-validation (CV) on the training data. When using the link prediction approach, the embedding is trained on the full network with all original and label nodes, but of the links between the original nodes and label nodes, only those corresponding to the training labels are included—not those corresponding to test labels. Links are then predicted based on the posterior probability of the links. For CNE-LP, two different types of prior information are included: just degrees (for both original and label nodes), and degrees combined with block information. Here we consider two blocks: (1) the original nodes, and (2) the label nodes. The block structural information thus accounts for the average connectivity between original nodes-original nodes, original nodes-label nodes, and label nodes-label nodes (which is zero, as label nodes are not connected to each other)

The Macro-F1 and Micro-F1 are calculated based on the predictions. As the logistic regression classifier (sklearn) used requires every fold to have at least one positive and one negative label, the labels that occur fewer than 10 times (number of folds in CV) in the data have been removed. The detailed results are shown in Table 2. In this table the F1 scores for multi-label classification are shown. For CNE-LR (degree), the embeddings are obtained with d=32 and k=150 (without optimizing). Somewhat surprisingly, CNE-LR (degree) still performs in line with the state-of-the-art graph embedded methods, although without improving on them (on BlogCatalog, CNE-LR (degree) performs third out of five methods, in PPI and Wikipedia it performs fourth out of five).

TABLE 2

| | BlogCatalog | | PPI | | Wikipedia | |
|---|---|---|---|---|---|---|
| Algorithm | Macro-F₁ | Micro-F₁ | Macro-F₁ | Micro-F₁ | Macro-F₁ | Micro-F₁ |

Multi-label classification using logistic regression (standard approach):

| | | | | | | |
|---|---|---|---|---|---|---|
| Deepwalk | 0.2544 | 0.3950 | 0.1795 | 0.2248 | 0.1872 | 0.4661 |
| LINE | 0.1495 | 0.2947 | 0.1547 | 0.2047 | 0.1721 | 0.5193 |
| node2vec | 0.2364 | 0.3880 | 0.1844 | 0.2353 | 0.1985 | 0.4746 |
| metapath2vec++ | 0.0351 | 0.1684 | 0.0337 | 0.0726 | 0.1031 | 0.3942 |
| CNE-LR (degree) | 0.1833 | 0.3376 | 0.1484 | 0.1952 | 0.1370 | 0.4339 |

Multi-label classification through link prediction where labels are nodes:

| | | | | | | |
|---|---|---|---|---|---|---|
| Common Neighbor | 0.2115 | 0.2931 | 0.1792 | 0.1831 | 0.1212 | 0.3332 |
| Jaccard Sim. | 0.2157 | 0.1915 | 0.1799 | 0.1642 | 0.0552 | 0.0486 |
| Adamic Adar | 0.2301 | 0.3198 | 0.1698 | 0.1825 | 0.1035 | 0.3264 |
| Preferential Attach. | 0.2460 | 0.2084 | 0.2504 | 0.0953 | 0.2890 | 0.4454 |
| Deepwalk | 0.2372 | 0.2407 | 0.1848 | 0.1648 | 0.0876 | 0.0440 |
| LINE | 0.1599 | 0.2457 | 0.1052 | 0.1100 | 0.0976 | 0.2954 |
| node2vec | 0.2490 | 0.3462 | 0.2081 | 0.2069 | 0.1640 | 0.3057 |
| metapath2vec++ | 0.0633 | 0.1415 | 0.0571 | 0.0542 | 0.2021 | 0.3673 |
| CNE-LP (degree) | 0.2839 | 0.3929 | 0.2139 | 0.2303 | 0.1825 | 0.4407 |
| CNE-LP (block + degree) | 0.2935 | 0.4002 | 0.2639 | 0.25195 | 0.3374 | 0.4839 |

The detailed results of the link prediction approach to multi-label classification are shown in the lower half of Table 2. CNE-LP (block+degree) consistently outperforms all baselines on Macro-F1, while it is better than or at least competitive with the baselines on Micro-F1. Note that while the benefit of this link prediction approach to multi-label classification is clear (and unsurprising) for CNE, there is no consistent benefit to other methods. This shows that the superior performance of CNE-LP for multi-label classification is not (or at least not exclusively) thanks to the link prediction approach, but at least in part also thanks to a more informative embedding when considered in combination with the prior.

We also evaluated CNE for building a recommender system, i.e. for link prediction in a network consisting of customers (individuals), products (here, movies), and attributes for the products. We evaluated this on the Movielens data combined with IMDB data for the meta data. The compiled dataset contains 943 customers, 1682 movies, and 19 genres plus 1154 directors as movie attributes (the ‘meta data’). There are 100000 links between customers and movies, 2893 links between movies and genres relations, and 1821 between movies and directors.

We conducted two different train-test splits of the links into 80% for training and 20% for testing: a first split where 20% of the links were selected uniformly at random for testing, and a second split where a random selection of 20% of the movies is made of which all links were used for testing. The second split simulates the cold start problem, as for the test movies no preference information at all is contained in the training set. For both types of splits, the evaluation is conducted with and without the product attributes (the ‘meta info’). The following AUC scores are obtained:

TABLE 3

| | Random | random | Cold | Cold |
|---|---|---|---|---|
| | removal | removal | start | start |
| | with | without | with | without |
| Algorithm | meta info | meta info | meta info | meta info |
| Deepwalk | 0.711 | 0.689 | 0.609 | 0.5 |
| LINE | 0.768 | 0.701 | 0.545 | 0.5 |
| node2vec | 0.869 | 0.874 | 0.718 | 0.5 |
| metapath2vec++ | 0.726 | 0.748 | 0.655 | 0.5 |
| CNE (block | 0.949 | 0.947 | 0.800 | 0.721 |
| and degree) | | | | |

These results demonstrate that conditional network embedding in accordance with embodiments of the present invention used for designing recommender systems combine the benefits of:

Collaborative filtering (by using purchases/likes). Indeed, with the random train-test split the accuracy is high irrespective of whether meta info is used

Content-based recommendation (by also embedding attributes of customers and products). Indeed, the accuracy remains reasonable (and much higher than the baselines) even in the cold start setup.

Next, we evaluate CNE for use as a network visualization method. The evaluation below demonstrates how CNE can be used to visually explore multi-relational data as well as how different priors will affect the embedding. For visual exploration, CNE is used to embed the studentdb dataset directly into 2-dimensional space. A larger σ₂ corresponds to stronger pushing and pulling effect, which in general appears to give better visual separation between node clusters. In this example σ₂ is set to 15. First CNE is applied with uniform prior (structural information just on the overall network density). The resulting embedding (FIG. 2) gives a clear separation between bachelor student/courses/program (upper) with the master's (lower). It is also observed that the embedding is strongly affected by the degree of nodes, as high degree nodes flock together in the center. E.g., these are the students who interact with many other smaller degree nodes (courses/programs). Although there are no direct connections between program nodes (pentagram) and course nodes (triangle), the students (diamond) that connect them are pulling the course towards the corresponding program and pushing away other courses. In this figure the following reference numbers are used: 210 for a Bachelor Program; 220 for a Master Program: Database; 230 for a Master Program: Computer Networks; 240 for a Master Program: Software Engineering; 250—Professor #19; 260—Professor #13.

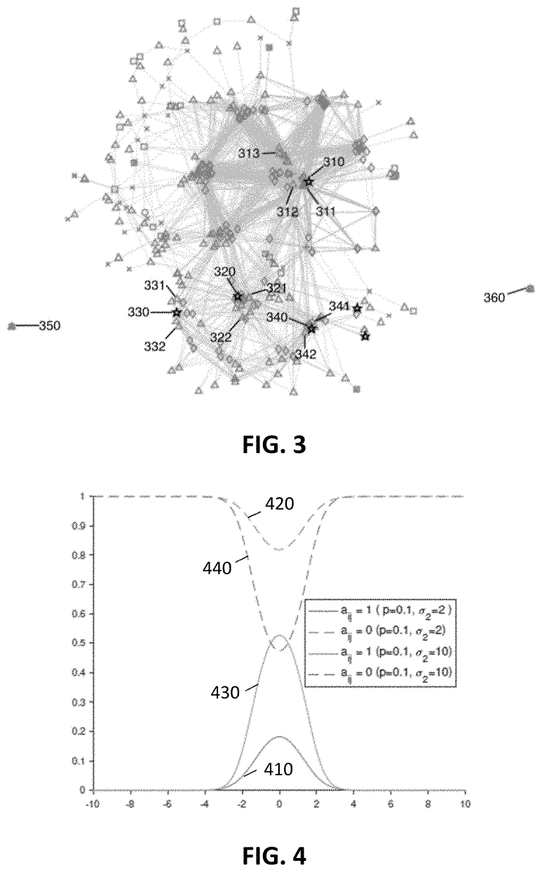

In FIG. 2 and FIG. 3, the following markers are used: a circle for a contract, a cross for a professor, a square for a room, a diamond for a student, a plus for a track, a triangle for a course, a pentagram for a program.

In FIG. 3, the individual node degrees are used as prior structural information. As in this case the degree information does not have to be represented by the embedding, the embedding in addition shows the courses grouped around different programs: “Bachelor Program” is close to courses “Calculus”, etc., “Master Program Computer Network” is close to courses “Seminar Computer Network”, etc., “Master Program Database” is close to courses “Database Security”, etc, “Master Program Software Engineering” is close to courses “Software Testing”, etc.

In FIG. 3 the following reference numbers are used: 310—Bachelor Program; 311—Calculus; 312—Computer Graphics; 313—Computer Networks; 320—Master Program: Database; 321—Database Security; 322—Project: Database; 330—Master Program: Computer Networks; 331—Seminar: Computer Network; 332—Mobile and Wireless Network; 340—Master Program: Software Engineering; 341—Software Re-engineering; 342—Software Testing; 350—Professor #19; 360—Professor #13.

In table 3 the runtime (in second) of CNE is compared with other baselines. The parameter settings in the link prediction task are used for all networks. Namely, for CNE, d is set to 8 (For arXiv d=16 to reduce underfitting) and k=50. The stopping criterion of CNE is set as follows: ∥∇ₓ∥_{∞}<10⁻² or maxlter <250 (whichever is met first). This stopping criterion yields embeddings with the same performance in link prediction tasks as reported above. Hyper parameters p, q of node2vec are tuned beforehand using cross validation. This experiment is performed with a single process/thread on a desktop with CPU 2.7 GHz Intel Core i5 and RAM 16 GB 1600 MHz DDR3. Table 4 summarizes the runtime of all methods against all datasets discussed above. Over the six datasets CNE is fastest in two cases, 12% slower than the fastest in one case (metapath2vec++), and approximately twice slower in the three other cases (also metapath2vec++).

TABLE 4

| Algorithm | Facebook | PPI | arXiv | BlogCatalog | Wikipedia | studentdb |
|---|---|---|---|---|---|---|
| Deepwalk | 120.78 | 116.09 | 714.68 | 344.72 | 138.89 | 8.34 |
| LINE | 253.20 | 203.92 | 649.98 | 218.20 | 232.11 | 180.35 |
| node2vec | 86.61 | 64.96 | 291.41 | 1054.73 | 288.32 | 6.04 |
| metapath2vec++ | 130.78 | 39.59 | 274.60 | 332.19 | 78.14 | 3.50 |
| CNE (uniform) | 86.89 | 75.15 | 728.74 | 227.11 | 92.35 | 7.25 |
| CNE (degree) | 77.80 | 70.35 | 579.85 | 204.48 | 87.69 | 6.80 |
| CNE (block) | NA | NA | NA | NA | NA | 10.68 |

In the following paragraphs supplementary material is given for detailed derivations. The density p(X|G) formulated as in Equation (4) is further elaborated. Further details are provided on the derivation of the gradient of the logarithm of the logarithm of the likelihood function from Equation (8). Denote the Euclidean distance between two points as dᵢⱼ [symbol] ∥xᵢ−xⱼ∥₂. The derivative of dᵢⱼ with respect to embedding xᵢ of node i reads:

$${∇}_{{x}_{i}} {d}_{i j} = \frac{{x}_{i} - {x}_{j}}{{d}_{i j}}$$

Then the derivative of the log posterior with respect to xᵢ has expression:

$${∇}_{{x}_{i}} log ( P ( G \vert X ) ) = {\sum }_{\{ i , j \} ∈ E} ( \frac{\partial log ( P ( G \vert X ) )}{\partial {d}_{i j}} + \frac{\partial log ( P ( G \vert X ) )}{\partial {d}_{j i}} ) {∇}_{{x}_{i}} {d}_{i j} + {\sum }_{\{ i , j \} ∉ E} ( \frac{\partial log ( P ( G \vert X ) )}{\partial {d}_{i j}} + \frac{\partial log ( P ( G \vert X ) )}{\partial {d}_{j i}} ) {∇}_{{x}_{i}} {d}_{i j} = 2 {\sum }_{\{ i , j \} ∈ E} \frac{\partial log ( P ( G \vert X ) )}{\partial {d}_{ij}} \frac{{x}_{i} - {x}_{j}}{\partial {d}_{ij}} + 2 {\sum }_{\{ i , j \} ∉ E} \frac{\partial log ( P ( G \vert X ) )}{\partial {d}_{ij}} \frac{{x}_{i} - {x}_{j}}{\partial {d}_{ij}}$$

For convenience, we introduce the following shorthand notation:

[symbol]

_{ij,σ}_{₁}= [symbol] ₊(dᵢⱼ|σ₁²)

[symbol]

_{ij,σ}_{₂}= [symbol] ₊(dᵢⱼ|σ₂²)

The partial derivative

$$\frac{\partial log ( P ( G \vert X ) )}{\partial {d}_{i j}} for \{ i , j \} ∈ E$$

can be computed as:

$$\frac{\partial log ( P ( G \vert X ) )}{\partial {d}_{ij}} = \frac{\partial }{\partial {d}_{ij}} {\sum }_{\{ i , j \} ∈ E} log ( {𝒩}_{ij , {σ}_{1}} {P}_{ij} ) - log ( {𝒩}_{ij , {σ}_{1}} {P}_{ij} + {𝒩}_{ij , {σ}_{2}} ( 1 - {P}_{ij} ) ) = \frac{{𝒩}_{ij , {σ}_{1}} {P}_{ij} \cdot \frac{- {d}_{ij}}{{σ}_{1}^{2}}}{{𝒩}_{ij , {σ}_{1}} {P}_{ij}} - \frac{{𝒩}_{ij , {σ}_{1}} {P}_{ij} \cdot \frac{- {d}_{ij}}{{σ}_{1}^{2}} + {𝒩}_{ij , {σ}_{2}} ( 1 - {P}_{ij} ) \cdot \frac{- {d}_{ij}}{{σ}_{2}^{2}}}{{𝒩}_{ij , {σ}_{1}} {P}_{ij} + {𝒩}_{ij , {σ}_{2}} ( 1 - {P}_{ij} )} = - \frac{{d}_{ij}}{{σ}_{1}^{2}} + P ( {a}_{ij} = 1 \vert X ) \frac{{d}_{ij}}{{σ}_{1}^{2}} + P ( {a}_{ij} = 0 \vert X ) \frac{{d}_{ij}}{{σ}_{2}^{2}}$$

Similarly, the partial derivative

$$\frac{\partial log ( P ( G \vert X ) )}{\partial {d}_{i j}} for \{ i , j \} ∉ E \frac{\partial log ( P ( G \vert X ) )}{\partial {d}_{i j}} = = - \frac{{d}_{i j}}{{σ}_{2}^{2}} + P ( {a}_{i j} = 1 \vert X ) \frac{{d}_{i j}}{{σ}_{1}^{2}} + P ( {a}_{i j} = 0 \vert X ) \frac{{d}_{i j}}{{σ}_{2}^{2}}$$

can be computed as:

Putting these things together finally yields the gradient from Equation (8):

$${∇}_{{x}_{i}} log ( P ( G \vert X ) ) = 2 {\sum }_{\{ i , j \} ∈ E} ( {x}_{i} - {x}_{j} ) P ( {a}_{i j} = 0 \vert X ) ( \frac{1}{{σ}_{2}^{2}} - \frac{1}{{σ}_{1}^{2}} ) + 2 {\sum }_{\{ i , j \} ∉ E} ( {x}_{i} - {x}_{j} ) P ( {a}_{i j} = 1 \vert X ) ( \frac{1}{{σ}_{1}^{2}} - \frac{1}{{σ}_{2}^{2}} )$$

For convenience in the optimization problem, based on the previous derivations the logarithm of the likelihood function P(G|X) can also be computed as follows:

$$log ( P ( G \vert X ) ) = log ( {\prod }_{\{ i , j \} ∈ E} \frac{{𝒩}_{ij , {σ}_{1}} {P}_{ij}}{{𝒩}_{ij , {σ}_{1}} {P}_{ij} + {𝒩}_{ij , {σ}_{2}} ( 1 - {P}_{ij} )} \cdot {\prod }_{\{ k , l \} ∉ E} \frac{{𝒩}_{kl , {σ}_{2}} ( 1 - {P}_{kl} )}{{𝒩}_{kl , {σ}_{1}} {P}_{kl} + {𝒩}_{kl , {σ}_{2}} ( 1 - {P}_{kl} )} ) = log ( {\prod }_{\{ i , j \} ∈ E} \frac{1}{1 + \frac{{𝒩}_{ij , {σ}_{2}} ( 1 - {P}_{ij} )}{{𝒩}_{ij , {σ}_{1}} {P}_{ij}}} \cdot {\prod }_{\{ k , l \} ∉ E} \frac{1}{1 + \frac{{𝒩}_{kl , {σ}_{1}} {P}_{kl}}{{𝒩}_{kl , {σ}_{2}} ( 1 - {P}_{kl} )}} ) = - {\sum }_{\{ i , j \} ∈ E} log ( 1 + \frac{{( 2 π {σ}_{2}^{2} )}^{- 1 \text{/} 2} exp ( - {d}_{ij}^{2} \text{/} ( 2 {σ}_{2}^{2} ) ) ( 1 - {P}_{ij} )}{{( 2 {πσ}_{1}^{2} )}^{- 1 \text{/} 2} exp ( - {d}_{ij}^{2} \text{/} ( 2 {σ}_{1}^{2} ) ) {P}_{ij}} ) - {\sum }_{\{ k , l \} ∉ E} log ( 1 + \frac{{( 2 π {σ}_{1}^{2} )}^{- 1 \text{/} 2} exp ( - {d}_{kl}^{2} \text{/} ( 2 {σ}_{1}^{2} ) ) {P}_{kl}}{{( 2 π {σ}_{2}^{2} )}^{- 1 \text{/} 2} exp ( - {d}_{kl}^{2} \text{/} ( 2 {σ}_{2}^{2} ) ) ( 1 - {P}_{kl} )} ) = - {\sum }_{\{ i , j \} ∈ E} log ( 1 + \frac{{σ}_{1}}{{σ}_{2}} \frac{1 - {P}_{ij}}{{P}_{ij}} exp ( ( \frac{1}{{σ}_{1}^{2}} - \frac{1}{{σ}_{2}^{2}} ) \frac{{d}_{ij}^{2}}{2} ) ) - {\sum }_{\{ k , l \} ∉ E} log ( 1 + \frac{{σ}_{2}}{{σ}_{1}} \frac{{P}_{kl}}{1 - {P}_{kl}} exp ( ( \frac{1}{{σ}_{2}^{2}} - \frac{1}{{σ}_{1}^{2}} ) \frac{{d}_{kl}^{2}}{2} ) )$$

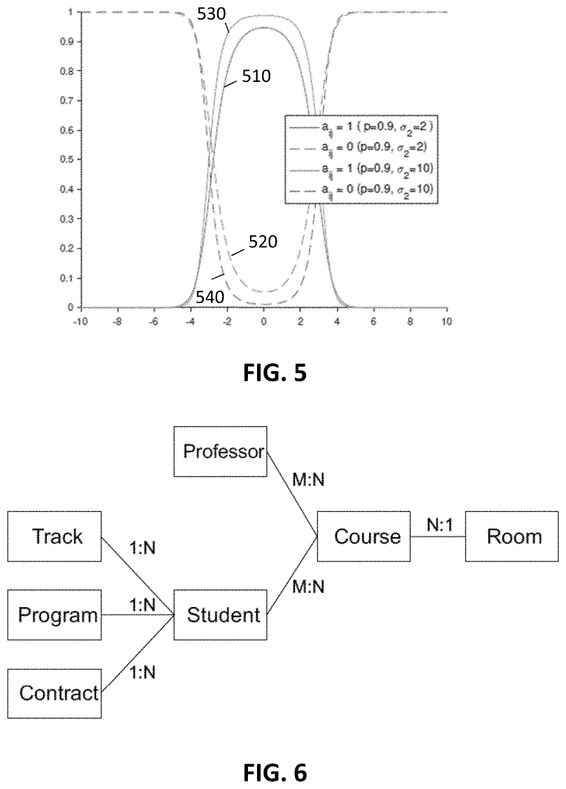

In the next paragraph the σ₁ and σ₂ parameters are interpreted w.r.t. the objective function. In embodiments of the present invention the CNE is sought for embedding X that maximizes the likelihood P(G|X) for given G. To understand the effect of parameter σ₁ and σ₂ the posterior distribution P(aᵢⱼ=1|X) and the posterior distribution P(aᵢⱼ=0|X) with different prior probabilities Pᵢⱼ and σ₂ are plotted in FIG. 4 and in FIG. 5.

The curves correspond with different prior probabilities Pᵢⱼ and σ₂. Curve 410 corresponds with aᵢⱼ=1 (p=0.1, σ₂=2), curve 420 corresponds with aᵢⱼ=0 (p=0.1, σ₂=2), curve 430 corresponds with aᵢⱼ=1 (p=0.1, σ₂=10), and curve 440 corresponds with aᵢⱼ=0 (p=0.1, σ₂=10). Curve 510 corresponds with aᵢⱼ=1 (p=0.9, σ₂=2), curve 520 corresponds with aᵢⱼ=0 (p=0.9, σ₂=2), curve 530 corresponds with aᵢⱼ=1 (p=0.9, σ₂=10), and curve 540 corresponds with aᵢⱼ=0 (p=0.9, σ₂=10).

The plot shows a large σ₂ corresponds to more extreme minima of the objective function (FIG. 4), thus resulting in a stronger pushing and pulling effect in the optimization. Large link probability in the network prior further strengthens the pushing and pulling effects (FIG. 5). The flat area in FIG. 5 allows connected nodes which keep a small distance from each other, but also makes the optimization problem harder.

In summary, the literature on network embedding has so far considered embeddings as tools that are used on their own. Yet, Euclidean embeddings are unable to accurately reflect certain kinds of network topologies, such that this approach is inevitably limited. In embodiments of the present invention the notion of Conditional Network Embeddings (CNEs) is introduced. In embodiments of the present invention CNE seeks an embedding of a network that maximally adds information with respect to certain prior knowledge about it. This prior knowledge could encode such information about the network that cannot be represented well by means of an embedding.

A CNE method may be implemented in an algorithm based on a probabilistic model for the joint of the data and the network, which scales similarly to state-of-the-art network embedding approaches. The empirical evaluation of this algorithm confirms that the combination of structural prior knowledge and a Euclidean embedding is extremely powerful. This is true in particular for the task of link prediction, where CNE matches and often outperforms all baselines (network embedding approaches as well as more standard approaches for link prediction) on a wide range of networks. A special case hereof is the use of CNE for multi-label classification. Another special case hereof is the use of CNE for recommender systems.

1. A computer-implemented conditional network embedding method to map nodes of a given network, comprising a set of links between the nodes, onto points in a d-dimensional Euclidean space wherein d is equal to 2 or larger, the method comprising:
identifying and modeling information about structural properties of the network related to the nodes and the set of links between them,
searching an embedding which maps information of the network which is not part of or implied by these structural properties onto points in the d-dimensional Euclidean space.

2. A computer-implemented conditional network embedding method according to claim 1, wherein modeling the information about the structural properties of the network comprises formalizing the information about the structural properties as a prior probability distribution P(G) over the set of links of the network.

3. A computer-implemented conditional network embedding method according to claim 2, wherein the prior probability distribution over the set of links of the network is computed as a distribution of maximum entropy subject to the information about the structural properties of the network.

4. A computer-implemented conditional network embedding method according to claim 1, wherein the network is a multi-partite network comprising a plurality of blocks and wherein the information about the structural properties comprises which nodes are belonging to which block and the number of links between each pair of such blocks.

5. A computer-implemented conditional network embedding method according to claim 1, wherein the information about the structural properties comprises a degree of connectivity of at least some of the nodes.

6. A computer-implemented conditional network embedding method according to claim 2, wherein searching the embedding comprises searching an embedding X that maximizes a likelihood function P(G|X) which represents a posterior distribution over the set of links of the network given the embedding X when considered together with the probability distribution P(G).

7. A computer-implemented conditional network embedding method according to claim 6, wherein the likelihood function P(G|X) is obtained by multiplying the probability distribution P(G) over the set of links of the network with a proper or improper conditional density function p(X|G) for the embedding X given the network and dividing it by a corresponding proper or improper marginal density function p(X) for the embedding X.

8. A computer-implemented conditional network embedding method according to claim 6, wherein maximizing the likelihood function is based on a block stochastic gradient descent approach.

9. A computer-implemented conditional network embedding method according to claim 7, wherein the proper or improper conditional density function p(X|G) for the embedding X given the network G is formulated as a product of density functions for pairs of the points in the embedding, wherein the mathematical form and wherein parameters of each of these density functions depend on the network G.

10. A computer-implemented conditional network embedding method according to claim 9, wherein the mathematical form and the parameters of the density function for any pair of the points is independent of the network when conditioned on knowledge whether the nodes represented by these points are linked in the network.

11. A computer-implemented conditional network embedding method according to claim 10, wherein the proper or improper conditional density function for any pair of points depends only on the pairwise distance between that pair of points in the embedding.

12. A computer-implemented conditional network embedding method according to claim 11, wherein density functions for the distances between pairs of points are such that a standard deviation of the distances between pairs of points which represent linked nodes in the network is smaller than a standard deviation of the distances between pairs of points which represent unlinked nodes in the network.

13. A link prediction method for predicting for any pair of nodes of a given network whether it is likely to be linked or unlinked in a more complete or more accurate version of the network than the given network, or whether it is likely to become linked or unlinked in the future as the network evolves, the method comprising applying a computer-implemented conditional network embedding method according to claim 1 on the given network and applying a link prediction algorithm on the obtained embedding in combination with the information about the structural properties of the network.

14. A link prediction method according to claim 13, where the link prediction method scores each pair of nodes using a posterior probability P(aᵢⱼ|X) for such pair of nodes to be linked or unlinked as computed from a likelihood function P(G|X) which represents a posterior distribution of the plurality of networks given the embedding X when considered together with the prior probability distribution P(G).

15. A label prediction method comprising a link prediction method according to claim 13 in a network augmented with a node for each possible label and a link between an original network node and an added label node whenever that label applies to that node, wherein a node is predicted to have a particular label if a link is predicted between that node and the corresponding label node by the link prediction method.

16. A recommender system comprising a link prediction method according to claim 13, the method comprising applying the link prediction method to a network with consumers and consumables as nodes, wherein links of the network indicate consumables which are recommended to consumers, to obtain new links between the customers and consumers.

17. A network visualization method comprising applying a computer-implemented conditional network embedding method according to claim 1 wherein identifying the information about the structural properties is selected such that certain information is filtered out, the method moreover comprising applying a link prediction algorithm on the obtained embedding.

18. An entity resolution method comprising a computer-implemented conditional network embedding method according to claim 1, where a distance between two node embeddings is used as a measure for the similarity between two nodes, and for the probability that they represent the same entity.
